(19) United States
(12) Patent Application Publication
(10) Pub. No.: US 2010/0203427 A1
(43) Pub. Date: Aug. 12, 2010

(54) FUEL CELL

(76) Inventors: Hiroyuki Hasebe, Chigasaki-shi (JP); Masakazu Kudo, Osato-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/067,743

(22) PCT Filed: Sep. 15, 2006
(86) PCT No.: PCT/JP2006/318418

§ 371 Date: Apr. 23, 2010

(30) Foreign Application Priority Data
Sep. 21, 2005 (JP) 2005-273841

(51) Int. Cl. H01M 4/92; H01M 4/02

(52) U.S. Cl. 429/524; 429/523

(57) ABSTRACT

A fuel cell includes a cathode, an anode, a proton-conductive film (6) arranged between the cathode and the anode and an oxidization catalyst layer (14) provided on an opposite side to a surface the cathode which faces the proton-conductive film (6) and containing an oxidization catalyst which oxidizes an organic substance.

### TECHNICAL FIELD

The present invention relates to a fuel cell comprising an anode catalyst layer to which a vaporized fuel obtained by vaporizing a liquid fuel is supplied.

### BACKGROUND ART

Recently, various types of electronic devices such as personal computers and mobile phones have been reduced in size along with the progress in the semiconductor technology, and there have been attempts of using a fuel cell as the power source of these small-sized devices. Fuel cells have such an advantage that they can generate power only by supplying the fuel and oxidizer thereto, and also they can continuously generate power by replenishing or replacing the fuel only. Therefore, the fuel cell is an extremely advantageous system for the operation of a mobile electronic device if the cell can be downsized. In particular, the direct methanol fuel cell (DMFC) can be reduced in size since it uses methanol, which has a high energy density, as the fuel and it can extracts a direct current from methanol on an electrode catalyst. Further, the handling of the fuel is easy as compared to the case of the hydrogen gas fuel. Therefore, the DMFC is a promising technology as the power for small-sized devices.

The DMFC is divided into various types according to the method of supplying the fuel thereto, that is: for example, a vapor-supply DMFC, in which the liquid fuel is vaporized and then the vaporized fuel is fed into the fuel cell with a blower or the like; a liquid-supply DMFC, in which the liquid fuel is directly fed into the fuel cell with a pump or the like; and an internal vaporization DMFC, in which the liquid fuel is vaporized in the cell.

Jpn. Pat. Appln. KOKAI Publications Nos. 2003-132931 and 2003-346862 are each directed to a liquid-supply DMFC. Jpn. Pat. Appln. KOKAI Publication No. 2003-132931 discloses that a reaction product storage chamber which can store a reaction product (water) produced by the power generation is provided on a cathode separator, and unreacted methanol and a catalyst are loaded in a container containing the reaction product storage chamber. The catalyst can render toxic substances harmless such as formaldehyde and formic acid, which are byproducts. On the other hand, Jpn. Pat. Appln. KOKAI Publication No. 2003-346862 discloses that as means for removing formaldehyde, formic acid, carbon monoxide, etc. generated as a result of incomplete oxidization of the fuel, a catalyst which can oxidize these materials is provided at the carbon dioxide discharge outlet of the cathode collector.

Also with regard to the internal vaporization DMFC, organic substances (for example, methanol and formaldehyde) remain in the cell due to the portion of the vaporization fuel which has not been consumed complete by the power generation, and therefore there is a demand for measures to be taken not to make these organic substances leak from the cell to the outside.

### DISCLOSURE OF INVENTION

An object of the present invention is to prevent organic substances from leaking from the cell to the outside. The present invention is suitable particularly for a fuel cell comprising fuel vaporization means which supplies a vaporized component of a liquid fuel to an anode catalyst layer.

According to the present invention, there is provided a fuel cell comprising:

a cathode;

an anode;

a proton-conductive film arranged between the cathode and the anode; and

an oxidization catalyst layer provided on an opposite side to a surface the cathode which faces the proton-conductive film, and containing an oxidization catalyst which oxidizes an organic substance.

### BRIEF DESCRIPTION OF DRAWINGS

FIG. 1 is a cross sectional view schematically showing a direct methanol fuel cell according to the first embodiment of the present invention; and

FIG. 2 is a cross sectional view schematically showing a direct methanol fuel cell according to the second embodiment.

### BEST MODE FOR CARRYING OUT THE INVENTION

For example, an organic component such as methanol of a vaporized fuel supplied to the anode from the fuel vaporization means is mostly consumed by the power generation, but is partially transmitted through the cathode as it is converted by partial oxidization or the like into an intermediate form or as it is in the original form. The intermediate form includes, for example, a ketone such as formaldehyde, or carboxylic acid such as formic acid. An oxidization catalyst layer containing an oxidization catalyst which can oxidize organic substances is provided on an opposite side to a surface of the cathode which faces the proton-conductive film. With this structure, methanol or these intermediates are converted into water and carbon dioxide, which are harmless, as they are oxidized by the catalytic reaction. Thus, it is possible to avoid the organic substances from leaking from the cell to the outside. In this manner, it is possible to realize a fuel cell which can hardly contaminate the environment even when a methanol aqueous solution having a concentration of more than 50% by molar or pure methanol is used as the liquid fuel.

The fuel cell of the present invention is characterized particularly in that the fuel is supplied to the anode by the fuel vaporization means which are designed to supply the vaporized component of the liquid fuel.

Further, an insulating layer is provided between the oxidization catalyst layer and the cathode, and with this structure, it is possible to avoid the creation of a hybrid potential between the oxidization catalyst layer and the cathode. Thus, the decrease in cathode potential can be suppressed, and therefore the decrease in voltage of the cell including the oxidization catalyst layer can be avoided.

In the fuel cell of the present invention, a moisture-retaining plate, which suppress the vaporization of water generated in the cathode, is provided between the oxidization catalyst layer and the cathode, and an insulating layer is provided on an opposite surface of the oxidization catalyst layer. Thus the decrease in voltage of the cell including the oxidization catalyst layer can be avoided. Also, with this structure, the diffusion of water from the cathode to the anode can be promoted, and therefore the output characteristics of the fuel cell can be improved.

Direct methanol fuel cells according to embodiments of the fuel cell of the present invention will now be described with reference to a drawing.

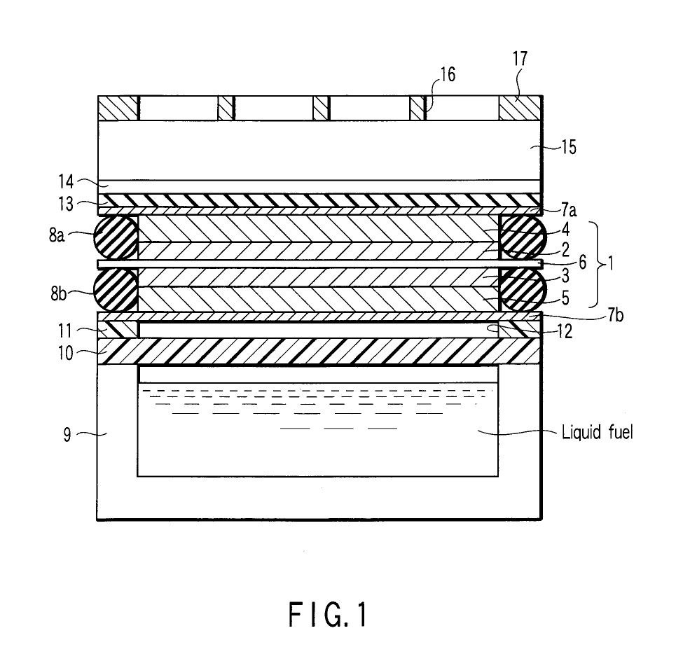

First, the first embodiment will be explained. FIG. 1 is a cross sectional view schematically showing a direct methanol fuel cell according to the first embodiment of the present invention.

As can be seen in FIG. 1, a membrane electrode assembly (MEA) 1 includes a cathode further including a cathode catalyst layer 2 and a cathode gas diffusion layer 4, an anode further including an anode catalyst layer 3 and an anode gas diffusion layer 5, and a proton-conductive electrolytic film 6 disposed between the cathode catalyst layer 2 and the anode catalyst layer 3.

Examples of the catalyst contained in the cathode catalyst layer 2 and anode catalyst layer 3 are simple platinum metals (such as Pt, Ru, Rh, Ir, Os, Pd, etc.), and alloys containing a platinum metal. Here, it is preferable that Pt—Ru, which is highly resistive to methanol and carbon monoxide, should be employed for the anode catalyst, and platinum be used for the cathode catalyst; however the materials are not limited to these. Alternatively, a supported catalyst which uses a conductive support such as a carbon material, or a non-supported catalyst may be employed.

Examples of the proton-conductive material which forms the proton-conductive electrolytic film 6 are fluorocarbon resins containing a sulfonic acid group (for example, perfluorosulfic acid polymer), hydrocarbon resins containing a sulfonic acid group, and inorganic materials such as tungstic acid and phosphotungstic acid, but it is not limited to these examples.

The cathode catalyst layer 2 is stacked on the cathode gas diffusion layer 4, and the anode catalyst layer 3 is stacked on the anode gas diffusion layer 5. The cathode gas diffusion layer 4 serves to supply the oxidizer uniformly to the cathode catalyst layer 2, and it also serves as a charge collector of the cathode catalyst layer 2. On the other hand, the anode gas diffusion layer 5 serves to supply the fuel uniformly to the anode catalyst layer 3, and it also serves as a charge collector of the anode catalyst layer 3. A cathode conductive layer 7a and an anode conductive layer 7b are set in contact with the cathode gas diffusion layer 4 and anode gas diffusion layer 5, respectively. For the cathode conductive layer 7a and anode conductive layer 7b, a porous layer (for example, a mesh) of a metal material such as gold can be used in each layer.

A cathode seal material 8a having a rectangular frame shape is situated between the cathode conductive layer 7a and the proton conductive electrolytic film 6 and also to surround the cathode catalyst layer 2 and the cathode gas diffusion layer 4. Meanwhile, an anode seal material 8b having a rectangular frame shape is situated between the anode conductive layer 7b and the proton conductive electrolytic film 6 and also to surround the anode catalyst layer 3 and the anode gas diffusion layer 5. The cathode seal material 8a and anode seal material 8b are O-rings which prevents the fuel and oxidizer from leaking from the membrane electrode assembly 1.

A liquid fuel tank 9 is provided underneath the MEA 1. The liquid fuel tank 9 contains liquid methanol or a methanol aqueous solution.

The fuel vaporization means (fuel vaporization layer) serves to selectively transmit the vaporized component of the liquid fuel (to be called as vaporized fuel hereinafter) and supply it to the anode. The opening end of a liquid fuel tank 9 has a vapor-liquid separation film 10 as the fuel vaporization means provided thereat, which, for example, transmits only the vaporized fuel but not the liquid fuel. Here, the term “vaporized fuel” means vaporized methanol in the case where liquid methanol is used as the liquid fuel, whereas it means a mixture gas containing a vaporized component of methanol and a vaporized component of water in the case where a methanol aqueous solution is used as the liquid fuel.

Between the vapor-liquid separation film 10 and the anode conductive layer 7b, a resin-made frame 11 is stacked. The space surrounded by the frame 11 functions as a vaporized fuel containing chamber 12 which can temporarily hold vaporized fuel diffused from the vapor-liquid separation film 10 (it is the so-called the vapor storage). Due to the effect of controlling the amount of transmitted methanol by the vaporized fuel containing chamber 12 and the vapor-liquid separation film 10, it is possible to avoid the supply of a great amount of vaporized fuel at once to the anode catalyst layer 3. Therefore, the occurrence of the methanol crossover can be suppressed. It should be noted that the frame 11 has a rectangular shape and it is formed of a thermoplastic polyester resin such as polyethylenetelephthalate (PET).

In the meantime, an oxidization catalyst layer 14 is stacked via an insulating layer 13 on the cathode conductive layer 7a stacked on the upper portion of the MEA 1. The oxidization catalyst layer 14 contains an oxidization catalyst which can oxidize organic substances originated from the portion of the vaporized fuel which is not consumed by the power generation. Examples of the organic substances are the unreacted methanol, and intermediates of methanol such as ketones including formaldehyde and carboxylic acids including formic acid. It is desirable that these organic substances should be converted into harmless substances such as water and carbon dioxide through oxidization caused by the catalytic reaction. Examples of the catalyst which has such a function are the cathode catalysts and anode catalysts mentioned above. Of these, an anode catalyst such as a Pt—Ru alloy is particularly preferable. Here, one or more types of oxidization catalysts can be used. A supported catalyst in which a catalyst is supported on fine particles may be used, or a non-supported catalyst may be used. The oxidization catalyst layer 14 is formed, for example, by rendering a mixture material containing an oxidization catalyst and a binder supported on a porous plate.

The insulating layer 13 serves to insulate the oxidization catalyst layer 14 and the cathode from each other. With this structure, it is possible to avoid the creation of a hybrid potential between the oxidization catalyst layer 14 and the cathode, and therefore the degradation of the voltage characteristics of the fuel cell can be prevented. It is preferable that the insulating layer 13 should be made of a porous insulating plate so as not to impair the diffusion of air. Examples of the insulating material which forms an insulating plate are porous bodies which have resin skeletons of polyethylene and polypropylene, and porous bodies made of ceramics such as of alumina and silica.

A moisture-retaining plate 15 is stacked on the oxidization catalyst layer 14. The moisture-retaining plate 15 serves to suppress the vaporization of water generated in the cathode catalyst layer 2 and it also serves as an auxiliary diffusion layer which promotes the uniform diffusion of the oxidizer to the cathode catalyst layer 2 by introducing the oxidizer uniformly to the cathode gas diffusion layer 4.

It is preferable that the moisture-retaining plate 15 should be formed of an insulating material which is inert to methanol and insoluble. Examples of the insulating material are polyolefins such as polyethylene and polypropylene.

It is preferable that the moisture-retaining plate 15 should have an air permeability defined by JIS P-8117-1998 of 50 sec/100 cm³ or less. If the air permeability exceeds 50 sec/100 cm³, the diffusion of air from an air introduction opening 16 to the cathode is blocked, and thereby a high output may not be obtained. A more preferable range of the air permeability is 10 sec/100 cm³ or less.

It is desirable that the moisture-retaining plate 15 should have a moisture permeability defined by JIS L-1099-1993 A-1 of 6000 g/m² 24 h or less. It should be noted that the value of the moisture permeability is one taken at a temperature of 40±2° C. as indicated in the measurement method for JIS L-1099-1993 A-1. If the moisture permeability exceeds 6000 g/m² 24 h, the amount of moisture vaporization from the cathode becomes excessive, and thereby it may become not possible to fully exercise the promotion of water diffusion from the cathode to the anode. On the other hand, if the moisture permeability is less than 500 g/m² 24 h, an excessive amount of water is supplied to the anode, and thereby a high output may not be obtained. Therefore, the moisture permeability should desirably set in a range of 500 to 6000 g/m² 24 h. A more preferable range of the moisture permeability is 1000 to 4000 g/m² 24 h.

A cover 17 in which a plurality of air introduction openings 16 as described above to take in air serving as the oxidizer are formed, is stacked on the moisture-retaining plate 15. The cover 17 also serves to press the stack including the MEA 1 to increase the tightness thereof, and therefore it is formed of such a metal as SUS304.

In the direct methanol fuel cell according to the first embodiment having the above-described structure, the liquid fuel (for example, methanol aqueous solution) in the liquid fuel tank 9 is vaporized, and vaporized methanol and water diffuse in the vapor-liquid separation film 10 and are temporarily contained in the vaporized fuel containing chamber 12. Then, the vaporized methanol and water gradually diffuse in the anode gas diffusion layer 5 to be supplied to the anode catalyst layer 3, where the internal reformation reaction of methanol indicated by the following reaction formula (1) occurs:

CH₃OH+H₂O→CO₂+6H⁺+6e⁻ (1)

On the other hand, in the case where pure methanol is used as the liquid fuel, there is no water supply from the fuel vaporization means. Therefore, water generated by the oxidization reaction of methanol mixed into the cathode catalyst layer 2 or the moisture and the like in the proton-conductive electrolytic film 6 reacts with methanol, which is the internal reformation reaction expressed by the reaction formula (1) provided above, or the internal reformation reaction occurs through some other reaction mechanism without using water, which is different from that indicated by the above formula (1).

Protons (H⁺) generated by the internal reformation reaction diffuse in the proton conductive electrolytic film 6 and reach the cathode catalyst layer 3. Meanwhile, the air taken in from the air introduction opening 16 of the cover 17 diffuses through the moisture-retaining plate 15, oxidization catalyst layer 1, insulating layer 13 and cathode gas diffusion layer 4, and then it is supplied to the cathode catalyst layer 2. In the cathode catalyst layer 2, water is generated by the reaction expressed by the following reaction formula (2):

(3/2)O₂+6H⁺+6e⁻→3H₂O (2)

As the power generation proceeds, water generated in the cathode catalyst layer 2 due to the reaction indicated by the formula (2) above, etc. diffuses in the cathode gas diffusion layer 4 and reaches the moisture-retaining plate 15. The vaporization of water is blocked by the moisture-retaining plate 15, and thus the moisture storage amount in the cathode catalyst layer 2 is increased. On the other hand, in connection with the anode, vaporized water is supplied through the vapor-liquid separation film 10, or no water is supplied. Therefore, as the power generation reaction proceeds, it is possible to create such a state that the moisture-retaining amount of the cathode catalyst layer 2 is larger than that of the anode catalyst layer 3. As a result, due to the osmotical phenomenon, such a reaction that water generated in the cathode catalyst layer 2 transmits through the proton conductive electrolytic film 6 and moves to the anode catalyst layer 3 is promoted, and therefore the internal reformation reaction of methanol indicated in the formula (1) mentioned above can be promoted. In this manner, the output characteristics of the fuel cell comprising the fuel vaporization means can be enhanced.

Further, with the moisture-retaining plate 15, it is possible to promote the water diffusion from the cathode to anode, and therefore high output characteristics can be achieved even in the case where a methanol aqueous solution having a concentration of more than 50% by molar or pure methanol is used as the liquid fuel. Further, with use of such a high-concentration liquid fuel, it becomes possible to reduce the size of the liquid fuel tank. Here, it is preferable that the purity of pure methanol should be set to 95% by weight or more but 100% by weight or less.

When the unreacted portion of methanol and the intermediates in the power generation reaction transmit through the insulating layer 13 and reach the oxidization catalyst layer 14, they are oxidized by the catalytic reaction and converted into water and carbon dioxide. In this manner, it is possible to avoid the organic substances from leaking from the cell to the outside.

Further, with the structure in which the moisture-retaining plate 15 is provided on the outer side of the oxidization catalyst layer 14, it is possible to inhibit the methanol and intermediates in the oxidization catalyst layer 14 from flowing back to the cathode even when they are not oxidized and are dissolved into water.

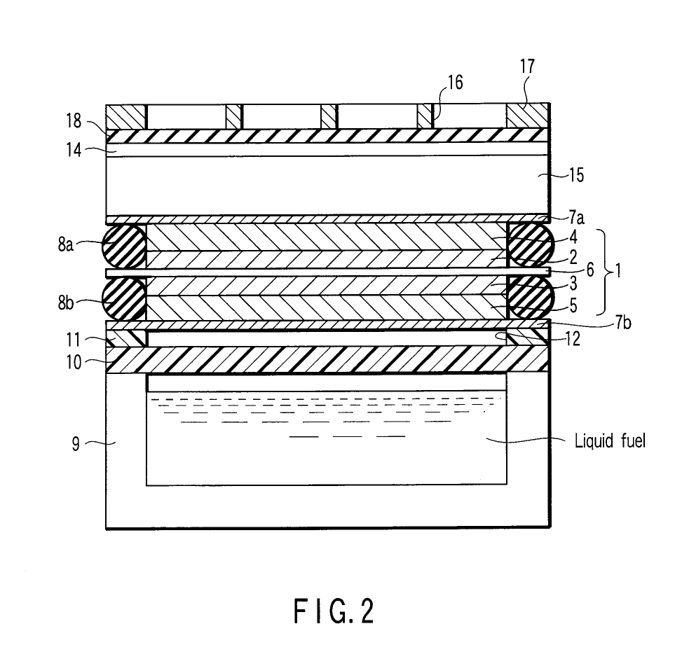

Next, the direct methanol fuel cell according to the second embodiment will now be described with reference to FIG. 2.

In the direct methanol fuel cell according to the second embodiment, the arrangement of the insulating layer, oxidization catalyst layer and moisture-retaining plate is different from that of the direct methanol fuel cell of the first embodiment.

That is, the moisture-retaining plate 15 is stacked on the cathode conductive layer 7a formed on the upper portion of the MEA 1. The oxidization catalyst layer 14 is provided on the moisture-retaining plate 15, and the cover 17 is stacked via the insulating layer 18 on the oxidization catalyst layer 14.

In the direct methanol fuel cell of the second embodiment, when the unused portion of methanol in the power generation and the intermediates transmit through the moisture-retaining plate 15 and reach the oxidization catalyst layer 14, they are oxidized by the catalytic reaction and converted into water and carbon dioxide. In this manner, it is possible to avoid the organic substances from leaking from the cell to the outside.

Further, the oxidization catalyst layer 14 is provided on the outer side of the moisture-retaining plate 15 and water is generated by the catalytic reaction in the oxidization catalyst layer 14; therefore the vaporization of water from the moisture-retaining plate 15 can be suppressed. Thus, it is possible to further promote the returning of water from the cathode to the anode. As a result, the cell characteristics can be further improved.

The insulating layer 18 serves to insulate the oxidization catalyst layer 14 and the metal-made cover 17 from each other. It is preferable that the insulating layer 18 should be formed of a porous insulating plate so as not to impair the air diffusion. Examples of the insulating material which forms the insulating plate are similar to those mentioned in the first embodiment described above.

### EXAMPLES

Examples of the present invention will now be described in details with reference to drawings.

### Example 1

### Manufacture of Anode

A perfluorocarbon sulfonic acid solution, water and methoxypropanol were added to catalyst (Pt:Ru=1:1) supported carbon black for an anode, and the catalyst-supported carbon black was dispersed therein, thereby obtaining a paste. The obtained paste was applied on porous carbon paper serving as an anode gas diffusion layer, and thus an anode having a thickness of 450 μm was obtained.

### <Manufacture of Cathode>

A perfluorocarbon sulfonic acid solution, water and methoxypropanol were added to catalyst (Pt) supported carbon black for a cathode, and the catalyst-supported carbon black was dispersed therein, thereby obtaining a paste. The obtained paste was applied on porous carbon paper serving as a cathode gas diffusion layer, and thus a cathode having a thickness of 400 μm was obtained.

A perfluorocarbon sulfonic acid film (nafion film of Du Pont) serving as the proton conductive electrolytic film and having a thickness of 30 μm and a moisture content of 10 to 20% by weight was placed between the anode catalyst layer and cathode catalyst layer, and the resultant was subjected to hot press, thereby obtaining a membrane electrode assembly (MEA).

An oxidation catalyst layer was manufactured by the method explained below. That is, a PTEE (polytetrafluoroethylene) dispersion serving as a binder was added to the same type of catalyst as that for the anode, and the mixture was kneaded. Then, the resultant was formed into a sheet having a thickness of 5 μm. Then, the obtained sheet was pressed to porous carbon paper having a thickness of 50 μm, thereby obtaining an oxidization catalyst layer.

As the insulating layer, a polypropylene-made porous film having a thickness of 50 μM was prepared.

As the moisture-retaining plate, a polyethylene-made porous film having a thickness of 500 μm and having an air permeability of 2 sec/100 m³ (JIS P-8117) and a moisture permeability of 4000 g/m² 24 h (JIS L-1099 A-1 method) was prepared.

The frame is made of PET and has a thickness of 25 μm. Further, as the vapor-liquid separation film, a silicone rubber sheet having a thickness of 200 μm.

The obtained membrane electrode assembly, oxidization catalyst layer, insulating layer, moisture-retaining plate, frame and vapor-liquid separation film were assembled into an internal vaporization-type direct methanol fuel cell having the above-described structure shown in FIG. 1. Then, 2 mL of pure methanol having a purity of 99.9% by weight was contained in the fuel tank.

### Example 2

A direct methanol fuel cell was manufactured to have the same structure as that described in Example 1 discussed above except that the insulation layer was not provided in this example.

### Example 3

A membrane electrode assembly, oxidization catalyst layer, insulating layer, moisture-retaining plate, frame and vapor-liquid separation film obtained in the same manner as that described in Example 1 provided above were assembled into an internal vaporization-type direct methanol fuel cell having the above-described structure shown in FIG. 2. Then, 2 mL of pure methanol having a purity of 99.9% by weight was contained in the fuel tank.

### Example 4

A direct methanol fuel cell was manufactured to have the same structure as that described in Example 3 discussed above except that the insulation layer was not provided in this example.

### Example 5

A direct methanol fuel cell was manufactured to have the same structure as that described in Example 1 discussed above except that the type of the catalyst used in the oxidization catalyst layer was changed to platinum (Pt) in this example.

### Example 6

A direct methanol fuel cell was manufactured to have the same structure as that described in Example 1 discussed above except that the type of the catalyst used in the oxidization catalyst layer was changed to Ir—Ru in this example.

### Comparative Example

A direct methanol fuel cell was manufactured to have the same structure as that described in Example 1 discussed above except that the oxidization catalyst layer and insulation layer were not provided in this example.

The fuel cells obtained in Examples 1 to 6 and Comparative Example were tested for power generation at a constant current density at room temperature, and the cell voltages of these were as indicated in TABLE 1 below. Further, for each cell, the amount of formaldehyde (HCHO) discharged from the air introduction opening of the cover of the fuel cell during the power generation test was measured with gas chromatography, and the result is also shown in TABLE 1 below.

TABLE 1

| | | | HCHO | Cell |
|---|---|---|---|---|
| | | Insulating | concentration | voltage |
| | Position of second catalyst layer | layer | (ppm) | (V) |
| Example 1 | Cathode/second catalyst layer/moisture-retaining plate | Present | 0.02 | 0.35 |
| Example 2 | Cathode/second catalyst layer/moisture-retaining plate | Absent | 0.03 | 0.27 |
| Example 3 | Cathode/moisture-retaining plate/second catalyst layer | Present | 0.04 | 0.33 |
| Example 4 | Cathode/moisture-retaining plate/second catalyst layer | Absent | 0.04 | 0.28 |
| Example 5 | Cathode/second catalyst layer/moisture-retaining plate | Present | 0.05 | 0.34 |
| Example 6 | Cathode/second catalyst layer/moisture-retaining plate | Present | 0.08 | 0.34 |
| Comparative | Without second catalyst layer | — | 0.22 | 0.35 |
| Example | | | | |

As is clear from TABLE 1, it is understood that the fuel cells of Examples 1 to 6, in which the oxidization catalyst layer, which oxidizes the organic substances, is provided on the opposite side of the cathode to the surface thereof which faces the proton-conductive film, each have a less amount of organic substance emitted to the outside of the cell as compared to the fuel cell of the comparative example in which no oxidization catalyst layer is provided.

Further, as comparing Example 1 with Example 2, the cell voltage is higher in Example 1. This is because the insulating layer provided between the oxidization catalyst layer and the cathode serves to suppress voltage drop. A similar tendency was observed also in Examples 3 and 4, in which the location of the oxidization catalyst layer was set different from that of Example 1.

From the results of Examples 5 and 6, it has been confirmed that if the type of oxidization catalyst was changed, a similar effect to that of Example 1 or 3 was obtained.

### INDUSTRIAL APPLICABILITY

According to the present invention, it is possible to prevent leakage of organic substances to the outside in, especially, a fuel cell including fuel vaporization means which serves to supply a vaporized component of liquid fuel to its anode catalyst layer.

1. A fuel cell comprising:
a cathode;
an anode;
a proton-conductive film arranged between the cathode and the anode; and
an oxidization catalyst layer provided on an opposite side to a surface the cathode which faces the proton-conductive film, and containing an oxidization catalyst which oxidizes an organic substance.

2. The fuel cell according to claim 1, which further comprises fuel vaporization means which supplies a vaporized component of a liquid fuel to the anode.

3. The fuel cell according to claim 2, wherein the liquid fuel is a methanol aqueous solution having a concentration of more than 50% by molar or liquid methanol.

4. The fuel cell according to claim 1, which further comprises an insulating layer provided between the oxidization catalyst layer and the cathode.

5. The fuel cell according to claim 4, wherein the insulating layer has a porous structure.

6. The fuel cell according to claim 1, which further comprises:
a moisture-retaining plate provided between the oxidization catalyst layer and the cathode, which suppress vaporization of water generated in the cathode; and
an insulating layer provided on an opposite surface of the oxidization catalyst layer.

7. The fuel cell according to claim 1, wherein the moisture-retaining layer is a polyolefin plate having an air permeability defined by JIS P-8117-1998 of 50 sec/100 cm³ or less, and a moisture permeability defined by JIS L-1099-1993 A-1 of 6000 g/m² 24 h or less.

8. The fuel cell according to claim 1, wherein the oxidization catalyst is at least one type selected from the group consisting of alloys containing platinum metals and simple metals of the platinum metal group.
